(19) United States
(12) Patent Application Publication
(10) Pub. No.: US 2004/0181466 A1
(43) Pub. Date: Sep. 16, 2004

(54) Method for providing advertising data, method for distributing advertising, and on-board advertising system

(75) Inventors: Takaharu Ishida, Hitachinaka (JP); Osamu Tomobe, Hitachi (JP); Takashi Kanakubo, Odawara (JP); Makoto Watanabe, Shime (JP)

Correspondence Address: CROWELL & MORING LLP, INTELLECTUAL PROPERTY GROUP, P.O. BOX 14300, WASHINGTON, DC, 20044-4300, US

(73) Assignees: Hitachi, Ltd.; RKB Mainichi Broadcasting Corporation

(21) Appl. No.: 10/781,649

(22) Filed: Feb. 20, 2004

(30) Foreign Application Priority Data
Mar. 15, 2003 (JP) 2003-081711

(51) Int. Cl. G06F 17/60

(52) U.S. Cl. 705/27

(57) ABSTRACT

An advertising system includes advertising data reception device which receives advertising request data at a data center from shops, a database which stores such data, a data converter which converts those data in a certain format, and a data transmission device for transmitting the converted data via a data distribution infrastructure, that provides an advertiser who is not familiar with know-how of advertising distribution with benefit to distribute advertising to public transportation through simple procedures. In addition, since advertising information such as time-limited services may easily be changed in real time by the advertiser, distribution of advertising according to needs becomes possible. It will be possible to provide passengers of the public transportation with distribution of advertising that is attractive.

### BACKGROUND OF THE INVENTION

The present invention relates to a business model to distribute advertising to public transportation and a method for realizing the same.

Technologies to distribute advertising to the conventional public transportation include the following publicly-known examples.

Publicly-known examples include an advertising distribution system which is capable of rewriting advertising information in real time according to areas through which a route bus passes, and a reservation system to reserve such advertising information as described in Japanese Patent Laid-open No. 2001-202455. This patent document also discloses that advertising is switched over to a still picture or character information while the bus is traveling, or to video images, etc. while the bus is in a stop.

In addition, it is known that, in order to realize advertising by means of video images and voices, a management company which is specialized in advertising that is posted in public transportation means such as a bus offers the distribution of advertising via a satellite as described in Japanese Patent Laid-open No. 2001-338216.

Other prior art examples include Japanese Patent Laid-open No. 10-075220, U.S. Pat. No. 2002-049054A1, and Fumihiko SUZUKI, “Present and Future of Route Buses”, Grand Prix Shuppan, 2001.

Japanese Patent Laid-open No. 2001-338216 refers to a model case in which a management company dealing with advertising exists between an advertiser and a transportation facility which receives advertising plays the role of an agent for advertising distribution procedures, etc. Here, at the time of collecting advertising data from a number of general advertisers, it is possible to create advertising data in a designated specific format if the advertisers are large-scale advertising providers represented by a franchise chain company. If they are small-scale ones represented by small and medium shop owners and restaurants, etc., however, such advertising data are created by using various media such as simple telephone communication, and paper-based media including facsimile transmission. Therefore, it is difficult to obtain the data in a unified format from advertisers.

### SUMMARY OF THE INVENTION

It is therefore an object of the present invention is to provide a method for providing advertising data, a method for distributing advertising, and an on-board advertising system, which can distribute advertising to public transportation through simple procedures.

According to an aspect of the present invention, there is provided an on-board advertising system which, in order to establish consistency in advertising data formats from every client for advertising, comprises: an advertising data reception device which receives advertising request data at a data center from shops; a database which stores such data; a data converter which converts the aforementioned data in a certain format; and a data transmission device for transmitting the converted data via a data distribution infrastructure.

### BRIEF DESCRIPTION OF THE DRAWINGS

Other objects and advantages of the invention will become apparent from the following description of embodiments with reference to the accompanying drawings in which:

FIG. 1 is a diagram showing a flow of data and a flow of charging status according to an embodiment of the present invention;

FIG. 2 is a diagram showing a system configuration according to an embodiment of the present invention;

FIG. 3 is a flowchart illustrating procedures according to an embodiment of the present invention;

FIG. 4 shows an example of advertising data from a shop;

FIG. 5 shows an example of database at a data center;

FIG. 6 shows an example of a reference table of stop Ids;

FIG. 7 is a flowchart illustrating a data display in a public transportation vehicle;

FIG. 8 is a diagram showing an example how to install an in-vehicle display device;

FIG. 9 shows an example of an advertising data display;

FIG. 10 is an example of real-time updating of data from an advertiser;

FIG. 11 is a diagram showing an example of a display device;

FIG. 12 is a diagram showing an example of a display device;

FIG. 13 is a diagram showing an example of a display device;

FIG. 14 is a diagram showing an example of a display device; and

FIG. 15 is a diagram showing an example of a display device.

### DETAILED DESCRIPTION OF THE EMBODIMENTS

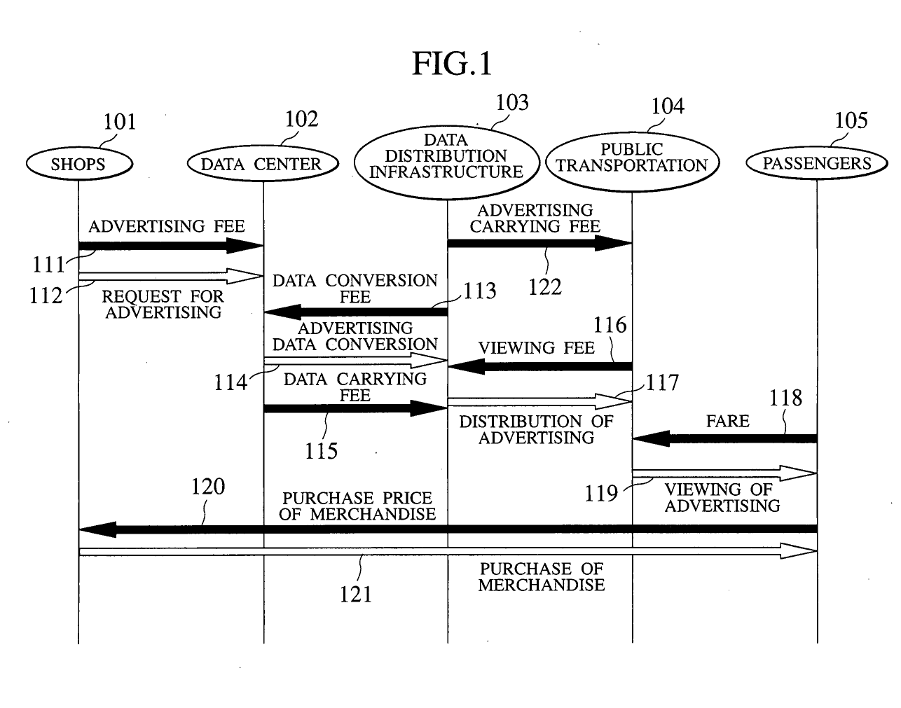

FIG. 1 is a diagram showing a process flow of an advertising distribution system according to an embodiment of the present invention. The system comprises shops 101 which distribute advertising to customers including public transportation, a data center 102 which collects display advertising requested by the shops and manages data concerned, a data distribution infrastructure 103 which receives advertising data that are converted into a unified format at the data center and distributes such data, a public transportation 104, as an example of a movable body, which has a terminal unit to receive advertising distributed from the data distribution infrastructure, and passengers 105 who get on the public transportation. Here, the public transportation shall include public transportation facilities that passengers use by paying fares, and which are represented by route buses, limousine buses, taxis, railways, streetcars and airplanes.

Each of a plurality of shops 101 provides an advertising fee 111 to the data center 102 and issues a request for advertising 112 to the data center 102. Forms of the request for advertising here are represented by documents, computerized text files, binary-formatted files, video images, pictures, and voice data. In addition, an oral request is also possible.

Thereafter, the data center 102 converts the requested advertising into a format that is requested by a data distribution infrastructure trader 103 (step 114), and pays a data carrying fee 115 to the data distribution infrastructure trader 103. On the other hand, when executing the data conversion of advertising data received from a shop into the format meeting the request by the data distribution infrastructure trader 103, the data center 102 collects a commission 113 from the data distribution infrastructure trader 103. Incidentally, it is also possible to simplify the payment flow in a manner to include the above-stated commission 113 and the data carrying fee 115 between the data center 102 and the data distribution infrastructure trader 103.

The data distribution infrastructure trader 103 which received advertising data in a desired format further executes data conversions such as the application of a header and the segmentalization of data that are agreeable with the infrastructure to distribute such data, and then distributes the data to a vehicle of the public transportation trader 104 (step 117). Here, it shall be so arranged that the public transportation trader 104 and the data distribution infrastructure 103 shall enter a data subscribing agreement under a viewing fee as shown by a step 116 in advance. In addition, an advertising carrying fee shall also be paid separately to the public transportation trader in advance under the agreement. Alternatively, it is possible to enter an accounting agreement according to the amount of data received or the time length of receiving data, and execute payment according to the amount of data received or the time length of receiving data.

A passenger taking the public transportation pays a fare 118 to the public transportation trader 104. During the ride, the passenger views advertising that is requested by the aforementioned shop 101 and that is distributed to the vehicle through the data center 102, the data distribution infrastructure trader 103 and the public transportation trader 104 in the vehicle (step 119). If the advertising motivates the passenger's buying inclination, the passenger will visit the shop 101 to purchase merchandise (step 121), and pay to the shop 101 for the merchandise. The shop 101 that earned sales in such a way will provide new advertising to the data center 102 to further increase the sales, and in such a way flows of expenses and data will be repeated. Here, in the above-stated preferred embodiment, the data distribution infrastructure 103 has an accounting feature, but another model that does not have any accounting function could be conceivable. More specifically, a step 115 continues to 122, 114 to 117, and 113 to 116, thus constituting a data carrying fee, an advertising data conversion, and an advertising data fee, respectively.

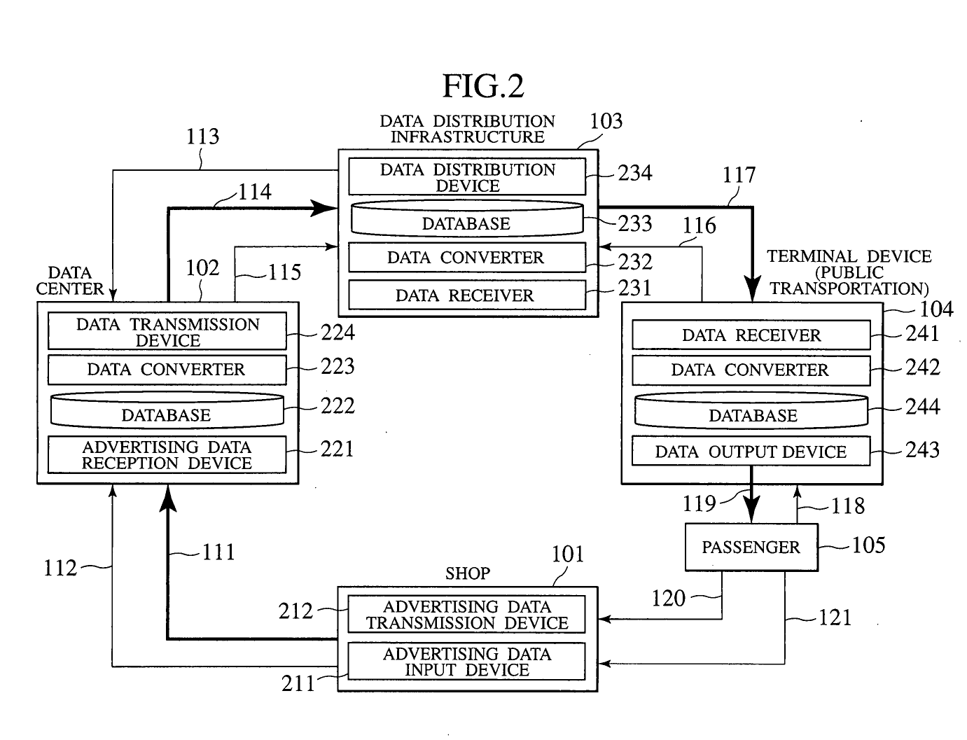

FIG. 2 is a diagram showing minimum-required devices to be installed in shops and respective traders referred to in FIG. 1. Each of shops 101 is provided with a device 211 and an advertising data transmission device 212. The device 211 receives advertising data prepared by the shop. The advertising data transmission device 212 transmits advertising data to the data center via communication equipment such as a modem. Here, means for transmitting data may include advertising data formatted in either computerized text format, or voices, video images or pictures prepared in the binary format, or otherwise, may be of documents to be transmitted via a facsimile. Also, depending on the circumstances, the measures may be such that delivers contents of advertising data orally from respective shops to the data center.

The data center 102 includes at least an advertising data reception device 221, a database 222, a data converter 223, and a data transmission device 224. The database 222 stores received data. The data converter 223 converts aforementioned advertising data of various formats that are received from shops to a specified format. The data transmission device 224 transmits data associated with the thus converted advertising to the data distribution infrastructure 103.

The data distribution infrastructure 103 includes at least a data receiver 231, a data converter 232, a database 233, and a data distribution device 234. The data receiver 231 receives converted advertising data from the data center 102. The data converter 232 processes and attaches a header required to distribute data from the data receiver 231 by using the infrastructure of communication or broadcasting, or which converts such data to a specified communication/broadcasting distribution data format. The database 233 temporarily stores the aforementioned converted data or such data that are received by the data receiver 231. The data distribution device 234 distributes the converted advertising data.

The public transportation 104 comprises a receiving terminal unit. The receiving terminal unit includes a data receiver 241, a data converter 242, a data output device 243, and a database 244. Since the data to be distributed from the data receiver 241 are typically compressed to reduce the data size, the data converter 242 restores the data to the uncompressed status. The data output device 243 outputs such converted data to a screen, etc.

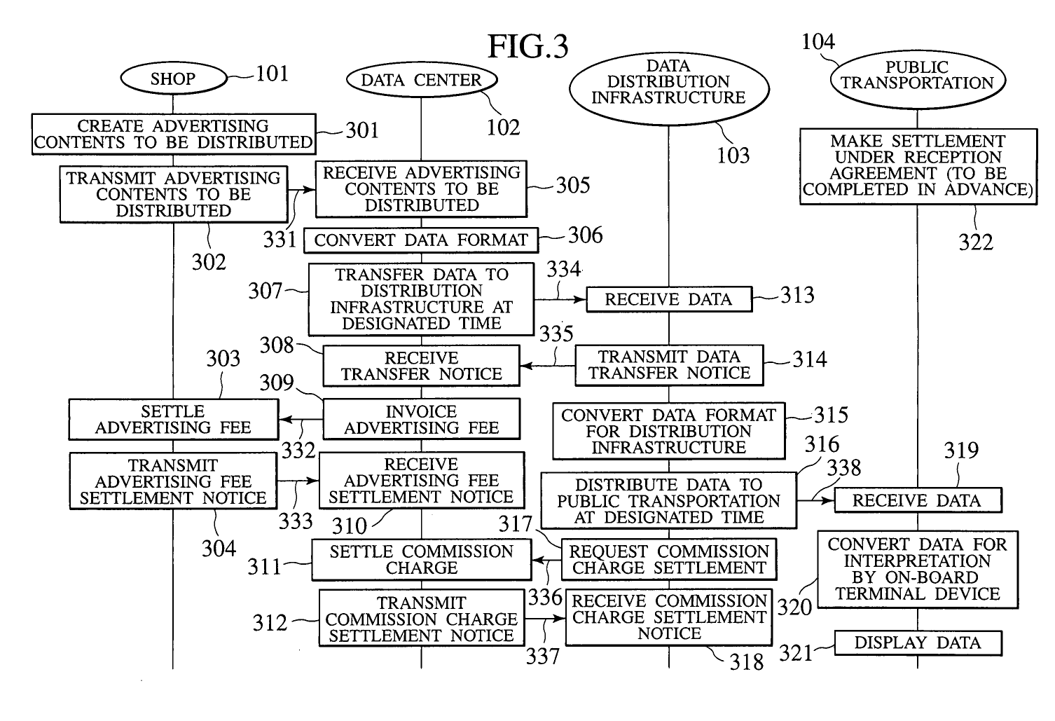

FIG. 3 shows a detailed description of processes ranging from a shop which is to make advertising, to a display device of a public transportation. First, the shop creates advertising distribution contents in a process 301. The contents are then transmitted to a process 302 (step 331). The advertising contents are received by the data center 102 in a process 305. Incidentally, here, for data communication 331 between the shop 101 and the data center 102 may be conducted with any measures that are capable of delivering advertising contents such as computerized data represented by a text file and a binary-coded file, communication measures represented by a facsimile, a floppy (registered trademark) disk, bridge media represented by a memory card, and oral requests via telephone.

In a process 306, advertising data received by the data center 102 in process 305 in various formats and various media are converted into data formats that are desired by the data distribution infrastructure trader 103, for example, in the forms of character-text data, simple graphics, simple video images and voices. The converted advertising data are transmitted by the data distribution infrastructure trader in a process 307 prior to the designated advertising distribution time stated in the advertising data (step 334). For communication means 334 here, an exclusive communication line, or other communication means such as the Internet and public telephone lines are used.

When the advertising contents are not of urgent nature, it is also possible to send them by one of the aforementioned bridge media. The data distribution infrastructure trader 103 receives advertising data in a process 313. The trader receives advertising data here and notifies that data distribution is ready to the data center (step 335). The data center receives such notification in a process 308 and charges the shop 101 for the advertising fee (step 332). After receiving the charge notice, the shop settles the advertising fee in a process 303, and notifies the data center 102 of the settlement of advertising fee via communication means 333 (step 304).

The data center 102 confirms that the shop 101 has completed the settlement of advertising fee in a process 310. Incidentally, in order to simplify processes and reduce costs, processes 309 to 303 and 304 to 310 may be executed only at the time of entering a fixed period contract. In this case, data concerning accounting are stored in the database 222 located in the data center 102 (FIG. 2). The data distribution infrastructure trader 103 which received advertising data from the data center 102 (step 333) converts, in a process 315, the thus transmitted data into a format adequate to be superposed on the data distribution infrastructure. More specifically, the typical processes here include the attachment of a data header and the packetization. After the data conversion, in a process 316, the data distribution infrastructure trader 103 distributes the advertising data to the public transportation by using a distribution media 338 according to the designated advertising time described in the advertising data.

The typical distribution media described in the above specifically include satellite communication, satellite broadcasting, terrestrial digital broadcasting, the Internet and a wireless LAN. A public transportation vehicle 104 receives the data transmitted with a receiver installed in the vehicle (step 319). After receiving the data, the receiver data-converts (decodes) the received data to output it to a display system (step 320). The advertising data are then displayed on a data display unit in a process 321 according to various conditions.

Thereafter, a commission charge settlement request 317 is executed to notify the data center 102 that the data distribution infrastructure trader 103 completed the data distribution. As a result, a commission charge settlement process 311 is executed at the data center 102 via communication 336. Upon completion of the settlement, the commission charge settlement notice is transmitted to the data distribution infrastructure trader 103 where a commission charge settlement notice is received (steps 337 and 318). Incidentally, at the time of requesting advertising to the data center 102 by a shop 101, it could be conceivable that modification of a data form already available in the data center is requested through telephone. In this case, before the data format is converted in the data format conversion process 306, a content modification function will be executed in advance.

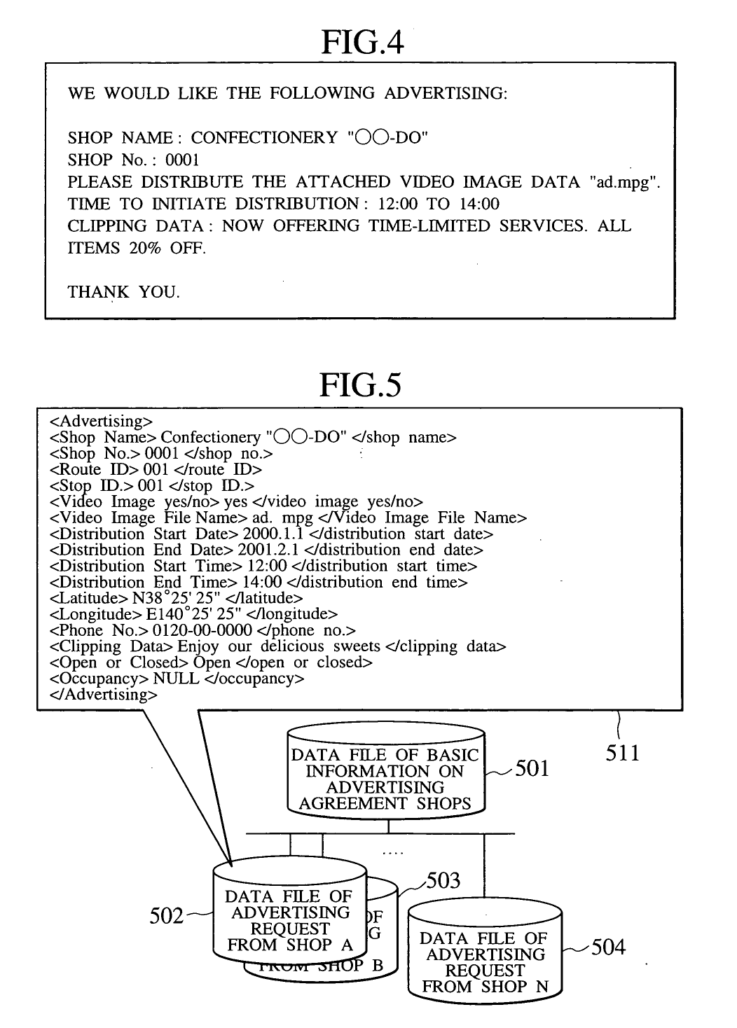

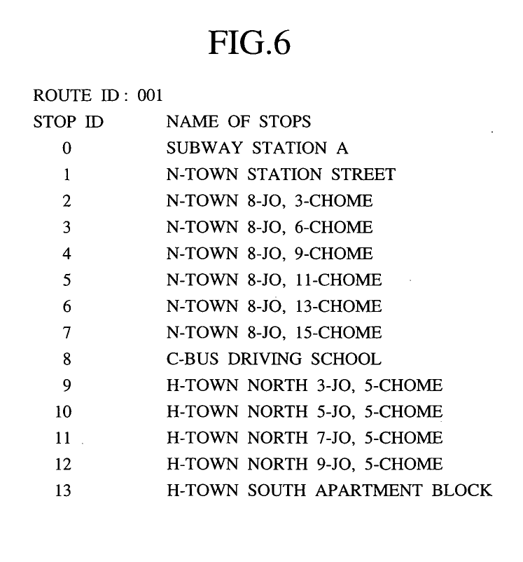

FIG. 4 shows an example of advertising data to be sent to the data center from each shop. The minimum required items for advertising data include a shop name, a shop identification number, availability and type of attached data, desired time or distribution time zone to initiate the distribution of advertising, and clipping data of services. Other accompanying information that would be suitable, in addition to the above, include a flag showing open/close status of shop, latitude/longitude of shop location, telephone number, appropriate route number of route bus, name of stop, number of stop, occupancy/vacant status of shop, and anticipated waiting time to be serviced.

FIG. 5 shows a preferred embodiment concerning the database in the data center. A database 501 stores basic information that is acquired at the time of a contract from a shop wishing to distribute advertising. Databases 502 to 504 store, for each shop, advertising data provided by respective shops. Reference numeral 511 shows an example of data converted into a specific desired format by a data distribution trader. The format shown in reference numeral 511 is a display example written in the Markup Language. The items to be indicated here include a shop name, a shop number, a route ID, a stop ID, availability of a video image file, a name of video image file, a start date of data distribution, an end date of data distribution, a distribution start time, a distribution end time, latitude of a shop, longitude of a shop, a telephone number, clipping data, open/close status of a shop, and occupancy/vacant status. As shown in reference numeral 511, the advertising data transmitted from respective shops are merged with the basic information of respective shops stated in the database 501 to enable the attachment of various pieces of information.

In distributing shop information along the bus routing of a route bus, information on the route concerned and bus stops concerned is required. The route ID and stop ID in reference number 511 is added to the advertising data 511 stated above if the route ID and stop ID coincide with the counterparts in a table containing stop IDs and a route ID and names of stops previously stored in the database 501.

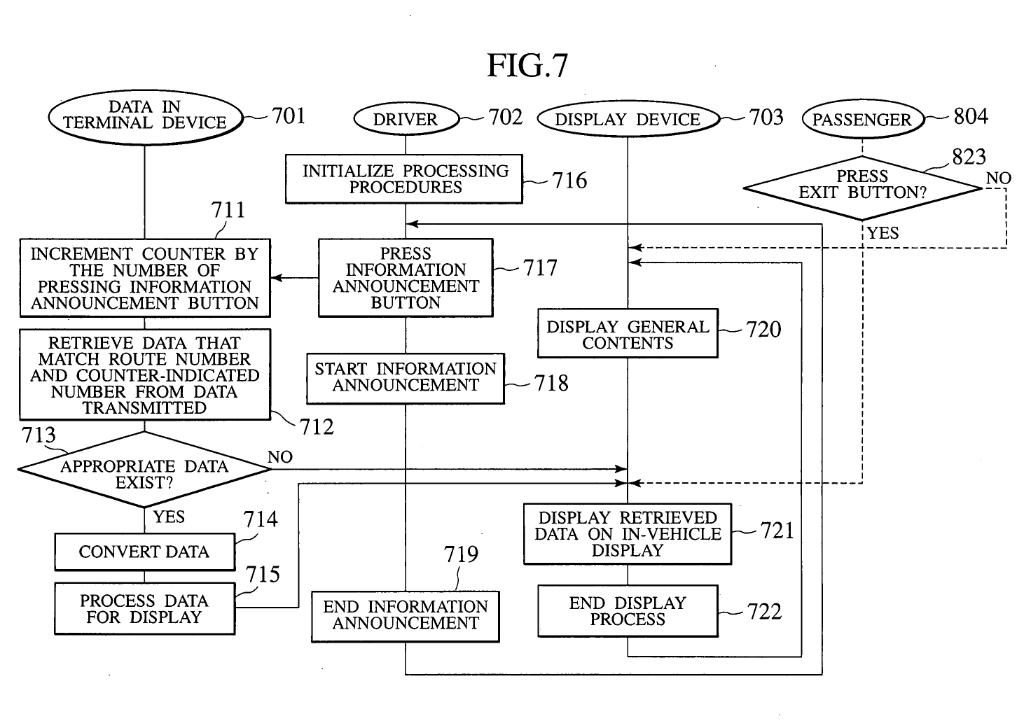

Next, procedures how the distributed advertising data are displayed in a public transportation vehicle will be described by referring to FIG. 7. Here, it shall be supposed that advertising data to be displayed as advertising in a certain time zone has already been distributed. In the example quoted in the following, a description will be made of a case where advertising suitable for the route and stops of a route bus are distributed to the route bus. It should be noted that, on a display unit in the vehicle, general contents are displayed in advance through a process 703.

First, the driver 702 of a bus executes initialization in a process 716 before pulling out the bus at a place of departure. Here, the typical initialization work involves setting of a route number of the bus, resetting of a bus-stop counter, initialization of a fare chart, and confirmation of the availability of media in which in-vehicle announcements are recorded.

When the bus starts to be in service, the driver presses a start button located on a side of the driver seat to reproduce an in-vehicle announcement (a process 717). Thereafter, the information announcement is initiated in a process 718. Accordingly, a computer in a terminal unit starts to increment the counter which memorizes the number of pressing the information announcement start button in a process 711.

Then, the availability of data that coincide with the route number and the above-stated number of counts that are set in the process 716 out of data that are transmitted in the computer and stored in the terminal unit are retrieved (a process 712). In a process 713, if appropriate data are available, data are converted into a format that enables such appropriate data to be displayed on the display unit (a process 714), and a display position on the screen is laid out (a process 715).

Thereafter, data processed in the process 715 are displayed on the in-vehicle display unit (a process 721). When the display finishes, the display of advertising information is ceased in a process 722 to switch over the display to general contents that had been displayed before the advertising information concerned is displayed. When the information announcement finishes in a process 719, a standby status is established until the information announcement button is pressed next.

It should be noted that, with the above-described example, a button disposed near the driver's seat for starting information announcement is used as a trigger to initiate the in-vehicle information announcement, but for a case of such bus that has a mechanism to reproduce the information announcement by judging the operation times of passenger door and the traveling speed of the bus, such trigger may be a time when the threshold value of a relational expression of the operation times of the passenger door and the traveling speed of the bus exceeds a certain predetermined value. In addition, it is also possible to display advertising, being triggered by the recognition of a certain signal recorded on a medium in which an information announcement is recorded.

In addition, for a railroad or a streetcar, the information announcement is in many cases conducted orally by a driver or a conductor instead of using recorded media for the information announcement. In such cases, it is possible to have a trigger to initiate the distribution of advertising by applying voice recognition to the information announcement to be done orally. Further, in countries other than Japan, the in-vehicle announcement is seldom executed. In such a case, it is possible that stops and stations are recognized by counting the operation times of boarding and exiting doors of a vehicle, and retrieving and displaying of advertising data to be distributed in the vehicle is executed based on such counter data. Furthermore, in the aforementioned embodiment, retrieval and distribution of advertising data to be distributed in the vehicle are executed by using technologies represented by the operations of doors in a bus as well as the voice recognition. On the other hand, it is of course possible to execute the retrieval and the display of data to be distributed to the vehicle by using position tracking technologies represented by GPS.

In FIG. 7, displaying of advertising information is initiated as the information announcement starts. One of other triggers to initiate the information announcement, for a route bus, is an exit button to allow a passenger to indicate his or her will to exit the bus. The flow in which a display of advertising is initiated when a passenger presses an exit button is indicated by dashed lines on the right of FIG. 7. It is also possible to add a judgment 823 whether or not a passenger 804 has pressed the exit button. After information announcement is initiated in the process 718, if a passenger wishes to exit the bus at the next stop, the passenger presses the exit button in the process 823. When pressing the exit button is confirmed, the in-vehicle display is changed to retrieved data in the process 720. On the other hand, if the exit button is not pressed, a process to display general contents that is already displayed in the process 720 is continuously executed.

Incidentally, heretofore information on shops located around respective bus stops is transmitted to the public transportation via the data distribution infrastructure trader as files whose data formats are converted in the data center. A certain parts of such data files are then stored in a terminal unit mounted in a public transportation car, and the data concerned are retrieved out of the stored data file to be outputted to a display unit. Alternatively, it is also possible, so far as the data distributing band permits, to allocate one channel to information of each shop located around respective stops, and continuously distribute advertising under the streaming mode. In this case, an additional method is also possible wherein a conversion table including names of stops, positional information and channels concerned is previously configured in a terminal unit mounted in a public transportation vehicle, and a channel to be displayed is changed to display necessary advertising data.

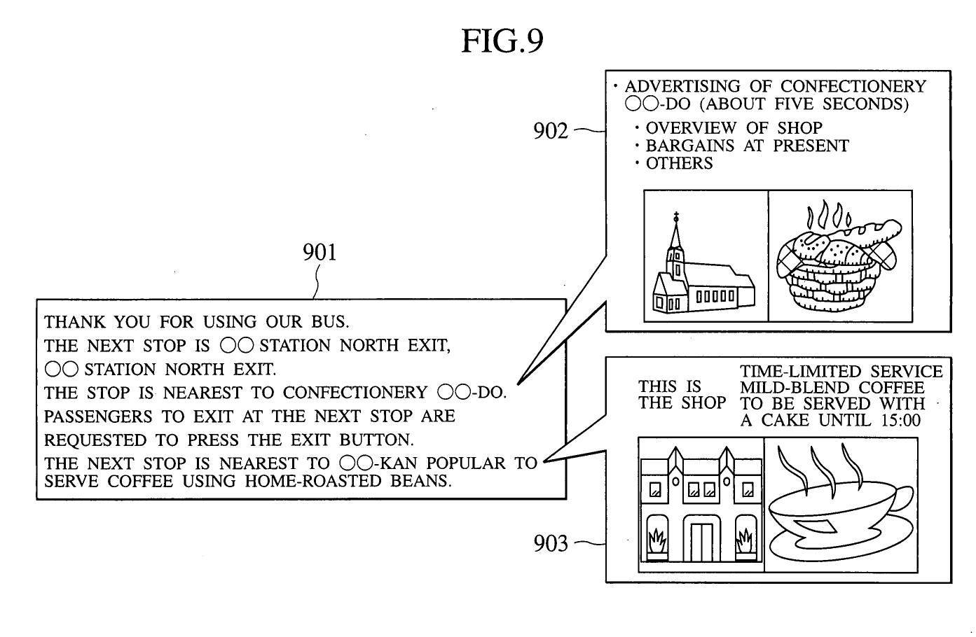

FIG. 9 is a diagram showing an example of display procedures concerning the in-vehicle announcement of a route bus, and advertising information to be displayed. To begin with, it shall be supposed that words shown in reference numeral 901 are announced through the in-vehicle announcement. First, when words “This is Confectionery ◯ ◯-Do” is announced, as shown in reference numeral 902, such data that are represented by an overview of the shop in the form of a still picture or simplified video images, present time-limited service items, and routes to get to the shop from the bus stop are displayed on the display unit in the public transportation. Then, upon finishing the announcement “passengers to exit at the next stop are requested to press the exit button”, an announcement “the next stop is nearest to ◯ ◯-Kan which is popular to serve coffee using home-roasted beans” is reproduced, and at the same time, an overview image or simplified video images of ◯ ◯-Kan, and beneficial information represented by time-limited services are displayed (reference numeral 903). In the example here, a case of distributing video images and still pictures is referred to. However, it is apparent that such advertising information that contains only texts are distributed without problems. In addition, since advertising information is capable of quickly reflecting real-time information from shops or advertisers, it becomes possible to allow passengers to recognize information beneficial to them as customers such as time-limited services before closing the shop, or other information on real-time discounts in service from time to time.

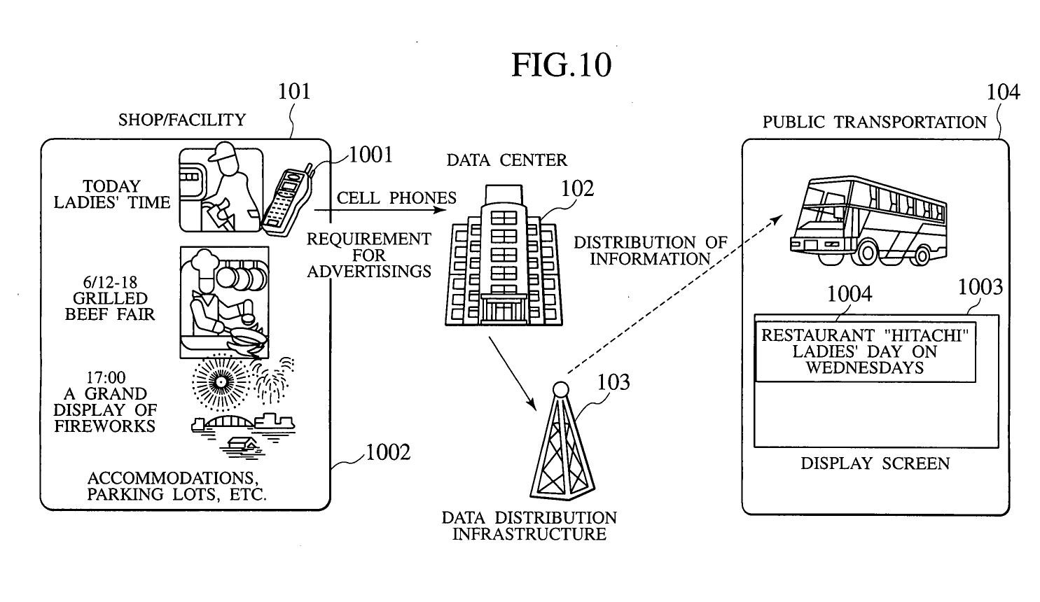

FIG. 10 shows an example of a method for reflecting real-time advertising information from a shop in advertising in public transportation is shown. It shall be supposed that a shop/facility 101 is provided with a cell phone as a data transmission device that can be connected to the Internet. It is possible to freely input real-time advertising update information from the shop 101, for example, advertising (reference numeral 1002) such as “Ladies' Time on and after 15:00 Today”, “Grilled Beef Fair from Tomorrow June 12 until June 18”, or “We will close at 6:30 due to a grand display of fireworks starting at 17:00” by making access from the cell phone 1001 to a certain URL of the data center 102. At the data center 102, if the advertising data reception device 221 is provided for equipment compatible with a WEB server, such information can be easily converted and reflected in real time. When the thus input data consist of text information only, the data may be presented to passengers, as shown by reference numeral 1003, by using a display method for superposing them on advertising video images being displayed originally (reference numeral 1004).

In a method for distributing advertising among advertising vehicles, the teletext broadcasting to be displayed on a TV screen in the vehicle is so arranged that, when a train is pulled into a certain station, a program received at a control center in the station building is tentatively fed into an in-vehicle computer, whereby the program is distributed to the respective TV sets in the vehicles. Such advertising as video image advertising whose data volume is large is fed in to the computer from the station through a train shed while the train is pulled into a train shed. In other words, in conventional methods, advertising contents to be delivered to train cars will not change unless the train passes through a particular station.

With such an indirect reception system as stated in the above, it is difficult to update data in real time. However, the use of a mechanism, as shown in FIG. 10, to directly receive advertising data from an infrastructure that transmits data can reduce installation costs of a base station and also reflect updated data in every vehicle in real time.

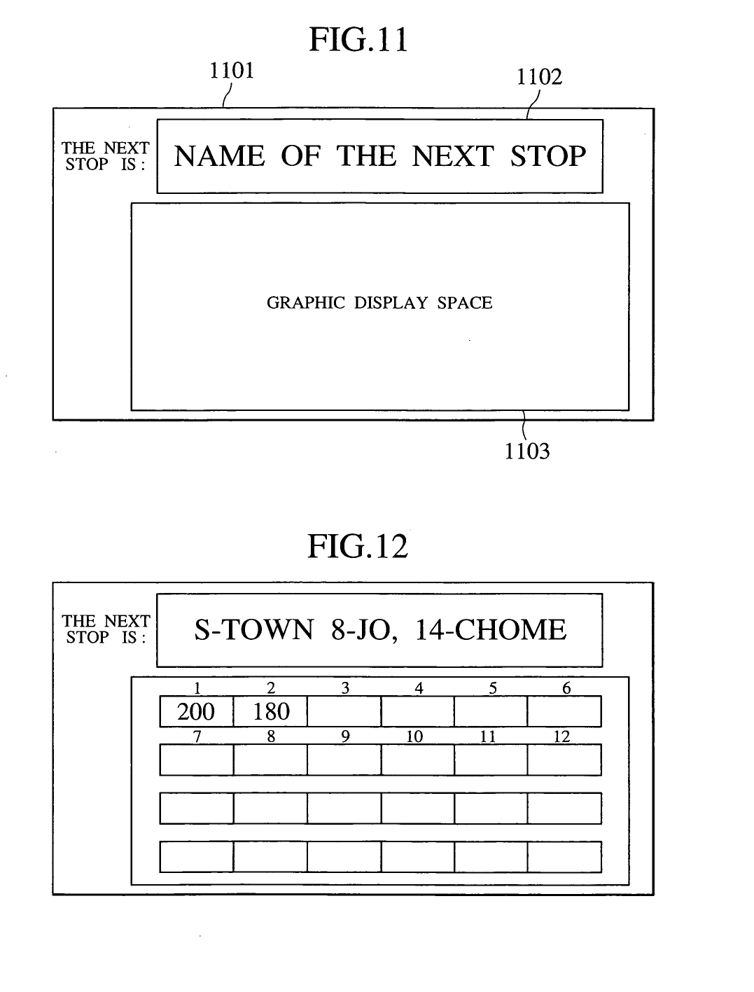

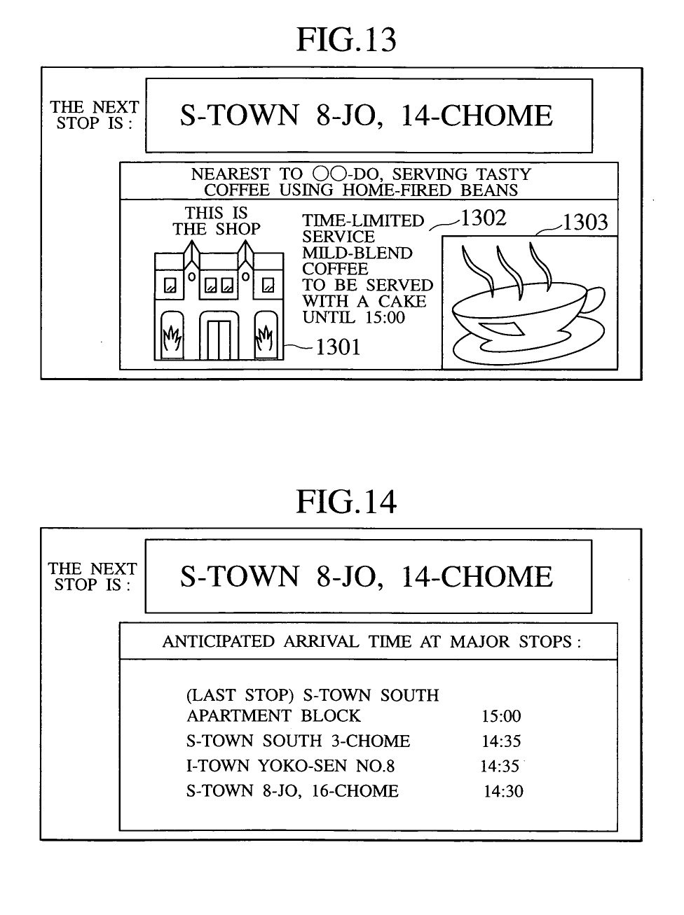

FIG. 11 shows a display device, which executes the advertising display in a public transportation vehicle as described in the above. FIG. 11 illustrates a form example wherein a name of the next stop or a name of the next station 1102 is displayed, and advertising information associated with the stop or the station is displayed in a graphic display space 1103. In the graphic display space 1103, it is also possible for a route bus, for example, to usually present fares as shown in FIG. 12 in a normal state before an in-vehicle information announcement is initiated. As the information announcement is initiated, or after a passenger presses the exit button as stated above, advertising information distributed from a shop is displayed in the graphic display space 1103 as illustrated in FIG. 13. For data concerning time-limited service as exemplified in FIG. 13, it is also possible to display information that is entered by a shop through an entering method described in FIG. 10 right before the time it is scheduled to be announced, or otherwise, distributed information entered in advance may be displayed. Contents to be displayed in the graphic display space may be either of: an overview of a shop 1301, clipping data 1302, simplified video images, image advertising using a picture 1303, or any combinations thereof.

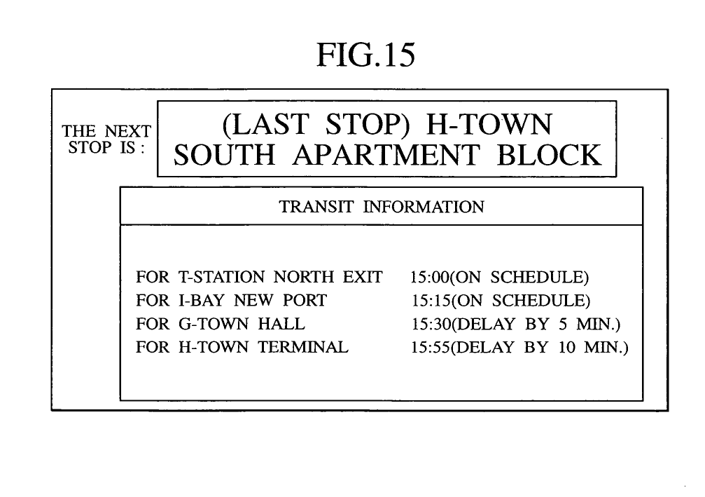

Specific display examples of general contents (the process 720) referred to in FIG. 7 before displaying above-stated advertising information of shops will be described by referring to FIGS. 14 and 15. FIG. 14 illustrates an example in which anticipated times that a bus passes through or arrives at major stops are displayed on the graphic display screen. FIG. 15 illustrates an example in which transfer information to major stops or stations is displayed. This information to be displayed may be data of timetable that are originally owned by the public transportation facility, or otherwise, based on such data, it is also possible to display data to which information on delay from the timetable that is calculated based on traffic information originally acquired by the public transportation facility is added may be displayed. Alternatively, information based on data of a public transportation information provider represented by the VICS may also be possible. For a simple display of a timetable, such data may be stored in a memory device in a terminal unit to be provided in a vehicle of a public transportation facility and may be displayed as they are. In addition, for a case to display a timetable or transfer information in which forecast information and correction information are reflected, corrected timetable information may be presented in real time in a vehicle of a public transportation facility by arranging a mechanism to distribute information on such difference from the data center, thus enhancing convenience for passengers.

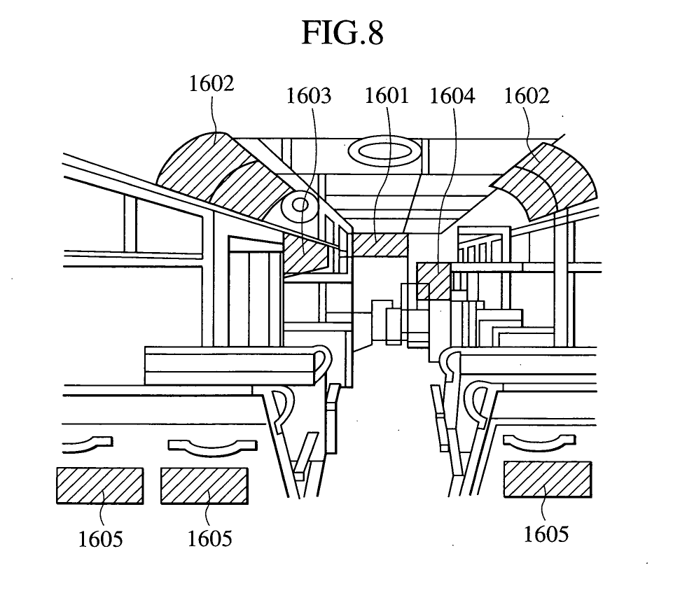

FIG. 8 shows positions for displaying advertising, taking a route bus as an example. Candidate in-vehicle positions of a route bus for advertising display using simplified video images or a picture include a front position 1601, upper positions 1602, the backside of a side destination screen 1603, the backside of the driver seat 1604, and backsides of passenger seats 1605. At the time of displaying the screen shown in FIG. 11 at these positions, it is likely that, when all displays present the same content at the same time, a passenger will miss the initial portion of the content if the passenger starts to see the advertising partway. A method for displaying advertising in railway vehicles displays a single content on all display devices at the same time with the same timing, whatever the content is of character information, picture information or video image information. In addition, since such advertising is displayed in a cyclic system, when a passenger starts to see the advertising partway and wishes to see it from the beginning, the passenger has to wait until a series of advertising goes through a cycle. For a case of a streetcar or a route bus, where the distance between stations or stops is short, it frequently happens that a vehicle arrives at the next stop before the advertising announcement ends.

To solve such problem, if a plurality of display devices are provided in a vehicle as shown in FIG. 8, therefore, the time difference in displaying advertising is provided. This enables a passenger to view the advertising concerned from the beginning just by changing his or her eye line, even when he or she notes the advertising is on its partway. More specifically, for example, supposing a case where advertising first starts at the front position 1601, the display of the same advertising will start several seconds later on the display device on the backside of the side destination screen 1603, and further several seconds later, the display will start on the display device on the backsides of passenger seats 1605, and thereafter, to be followed by the display on the display device on the backside of the driver seat 1604, and finally on the display device on the upper sides 1602.

Of course, it is possible to change the display sequence at will, and also to change the display sequence according to conditions of: the age bracket of passengers in a vehicle, for example, the state in which young passengers are major or senior passengers are major, or time zones in which cars are operated. In addition, although the above description referred to an example where the same advertising content is displayed on every display device in the vehicle, it is also possible to display different advertising contents according to the above-stated conditions such as of the age bracket of persons in a vehicle, operating time zones, etc., by changing setting parameters of a terminal unit mounted in the vehicle.

Further, in addition to the display of such advertising on a display device provided in a traveling vehicle, the display on an exterior wall of the car will enable more effective advertising.

The adoption of an advertising distribution and display system as described in the above, and the provision of a data center which has a function to temporarily store advertising data from a shop desiring to make advertising and convert such advertising data into a format requested by a trader which utilizes the data, and another function to collect other information associated with the peripheral area of a shop, temporarily store such information, and convert the data into a format requested by a trader which utilizes the data, enable an advertiser who is not familiar with know-how of advertising distribution to distribute advertising to a public transportation through simple procedures. In addition, since an advertiser can easily change advertising information including time-limited services in real time, it is possible to distribute advertising according to different needs.

Further, distribution of advertising that is attractive to passengers of the public transportation will improve the rate of boarding for a public transportation facility, and it is also possible for a shop to make the shop better known and to increase its sales through the visits of such passengers who saw the distributed advertising to the shop of the advertiser. In addition, since advertising information associating with stops or stations of vehicles is distributed to in-vehicle passengers for enhanced advertising effect, increased sales of an advertiser's shop can be expected.

According to the present invention, it is possible to distribute advertising to public transportation through simple procedures.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A method for providing advertising data in which advertising is collected from an advertiser in a data center and said advertising is provided to an advertising data distribution trader from said data center, said method for providing advertising data, comprising the steps of:
receiving advertising data from an advertiser;
storing the received advertising data in a database;
converting said advertising data into a format that is required by an advertising data distribution trader which distributes said advertising data, by use of a data converter; and
transmitting said converted advertising data to said advertising data distribution trader by use of a data transmission device.

2. A method for providing advertising as claimed in claim 1, wherein information associated with the periphery of a shop of the advertiser is stored in said database in addition to said advertising data; and
said data converter converts said advertising data and the information associated with the periphery of the shop of the advertiser into a format as required by said advertising data distribution trader.

3. A method for distributing advertising, wherein a data distribution infrastructure trader receives advertising which is requested by an advertiser to a data center as advertising data from said data center in a data format requested by the data distribution infrastructure trader itself, and transmits said advertising data to a movable body as an advertising receiving medium.

4. A method for distributing advertising as claimed in claim 3, wherein said movable body is a movable body of public transportation facilities including a train and a bus.

5. An on-board advertising system in which advertising data are received through communication from a data distribution infrastructure trader, and advertising is displayed in a vehicle on a basis of the thus received advertising information, said on-board advertising system comprising:
an advertising display unit for displaying at least one piece of advertising.

6. An on-board advertising system as claimed in claim 5, wherein said on-board advertising system is provided with an input button to initiate an in-vehicle announcement, and displaying of said advertising information to be distributed to the vehicle is initiated when said input button is depressed.

7. An on-board advertising system as claimed in claim 5, wherein, when an exit notifying button to be operated by a passenger is depressed, said on-board advertising system receives information on a passenger's wish to exit a bus to thereby initiate the display of said advertising information to be distributed to the vehicle.

8. An on-board advertising system as claimed in claim 5, further comprising detection means for detecting a position of the host vehicle;
wherein said on-board advertising system displays advertising information to be distributed to said host vehicle on the basis of positional information about the host car detected by said detection means and positional information about a shop of an advertiser included in said advertising information.

9. An on-board advertising system as claimed in claim 5, wherein said on-board advertising system displays advertising information to be distributed to the vehicle on the basis of the number of operating a passenger door of the vehicle.

10. An on-board advertising system as claimed in claim 5, wherein said on-board advertising system displays advertising information to be distributed to the vehicle on the basis of the number of operating a passenger door of the vehicle and a traveling speed of the vehicle.

11. An on-board advertising system as claimed in claim 5, wherein information about at least one of arrival time of the host vehicle as a public transportation facility, transfer information, music data, video image data, and picture data is displayed on said advertising display unit if no advertising information from said advertiser is displayed.

12. An on-board advertising system as claimed in claim 5, wherein said on-board advertising system is provided with a plurality of advertising display units, and the plurality of advertising display units display the advertising information with a time difference.

13. An on-board advertising system as claimed in claim 5, wherein said advertising information to be displayed in the host vehicle is changed according to traveling time zones of the host vehicle.

14. An on-board advertising system as claimed in claim 5, further comprising a ticket issuing device capable of issuing tickets including a coupon as desired by a passenger who saw advertising information distributed to the vehicle.
